(19) United States
(12) Patent Application Publication
(10) Pub. No.: US 2023/0316171 A1
(43) Pub. Date: Oct. 5, 2023

(54) INFORMATION DEVICE

(71) Applicant: DENSO CORPORATION, Kariya-city (JP)

(72) Inventors: Masakatsu SHIGYO, Kariya-city (JP); Mitsuharu HIGASHITANI, Kariya-city (JP); Noriaki IKEMOTO, Kariya-city (JP)

(73) Assignee: DENSO CORPORATION, Kariya-city (JP)

(21) Appl. No.: 18/124,944

(22) Filed: Mar. 22, 2023

(30) Foreign Application Priority Data
Apr. 5, 2022 (JP) 2022-062784

(51) Int. Cl. G06Q 10/0631; G01C 21/34

(52) U.S. Cl. CPC G06Q 10/0631; G01C 21/3476; B60L 53/50

(57) ABSTRACT

In an information device for providing information about one or more chargers for charging a rechargeable battery of a vehicle, a first acquisition unit configured to acquire a maximum amount of power chargeable to the rechargeable battery, and a second acquisition unit configured to acquire a specification of each of the one or more chargers in a vicinity of the vehicle. A selection unit is configured to select at least one recommended charger from the one or more chargers based on the maximum amount of power and the specification of each of the one or more chargers in the vicinity of the vehicle. A notification unit is configured to provide a notification of the selected at least one recommended charger.

### CROSS-REFERENCE TO RELATED APPLICATION

The present application is based on and claims the benefit of priority from Japanese Patent Application No. 2022-062784 filed in Japan on Apr. 5, 2022, all the disclosure of which is incorporated herein by reference.

### BACKGROUND

### Technical Field

This disclosure relates to an information device.

### Related Art

Vehicles that are driven by stored electric power, such as electric vehicles and plug-in hybrid vehicles, are becoming increasingly popular. Such vehicles need to be connected to chargers to charge their rechargeable batteries to avoid shortage of power stored in the rechargeable batteries. A known information device is capable of indicating locations of chargers on a map and providing various information about the chargers to a user of a vehicle carrying the information device. The information provided by such an information device includes, for example, information on charging fees and charging times. Such an information device allows the user to select the most appropriate charger from a plurality of chargers around the vehicle.

### BRIEF DESCRIPTION OF THE DRAWINGS

In the accompanying drawings:

FIG. 1 is a schematic diagram of a configuration of a vehicle equipped with an information device according to one embodiment;

FIG. 2 is a functional block diagram of the information device according to the embodiment;

FIG. 3 is an illustration of a relationship between temperature of a rechargeable battery and maximum charging power;

FIG. 4 is an illustration of a relationship between amount of charge stored in the rechargeable battery and maximum charging power;

FIG. 5 is an illustration of an example of a notification provided by the information device according to the embodiment;

FIGS. 6A and 6B are an illustration of factors that affect selection of a charger,

FIG. 7 is a flowchart of a process performed by the information device according to the embodiment;

FIG. 8 is an illustration of temperature control of the rechargeable battery;

FIG. 9 is an illustration of effects of power consumed by vehicle accessories on charging power; and

FIGS. 10A and 10B are an illustration of charging fees.

### DESCRIPTION OF SPECIFIC EMBODIMENTS

Charging fees, charging times and the like are not determined only by the specifications of chargers, but also vary depending on the state of the rechargeable battery mounted to the vehicle and other factors. Thus, even if the above known information device, as disclosed in JP 2020-193903 A, presents the specifications of chargers to the user, the user may not be able to properly determine which charger should be used to charge the rechargeable battery of the vehicle.

In view of the foregoing, it is desired to have an information device capable of providing information necessary to select an appropriate charger.

One aspect of the present disclosure provides an information device for providing information about one or more chargers for charging a rechargeable battery of a vehicle. The information device includes a first acquisition unit configured to acquire a maximum amount of power chargeable to the rechargeable battery, a second acquisition unit configured to acquire a specification of each of the one or more chargers in a vicinity of the vehicle, a selection unit configured to select at least one recommended charger from the one or more chargers based on the maximum amount of power and the specification of each of the one or more chargers in the vicinity of the vehicle; and a notification unit configured to provide a notification of the selected at least one recommended charger.

The information device configured as above selects at least one recommended charger from one or more chargers based not only on a specification of each of the one or more chargers in the vicinity of the vehicle, but also on the maximum amount of power chargeable to a rechargeable battery of the vehicle and provides a notification of the at least one recommended charger. This allows, for example, a vehicle user, to select an appropriate charger based on the notification.

The present disclosure can provide an information device capable of providing information necessary to select an appropriate charger.

Hereinafter, an exemplary embodiment will be described with reference to the accompanying drawings. In order to facilitate understanding of the description, the same structural or functional elements in the drawings share the same reference signs wherever possible, and overlapping description is omitted.

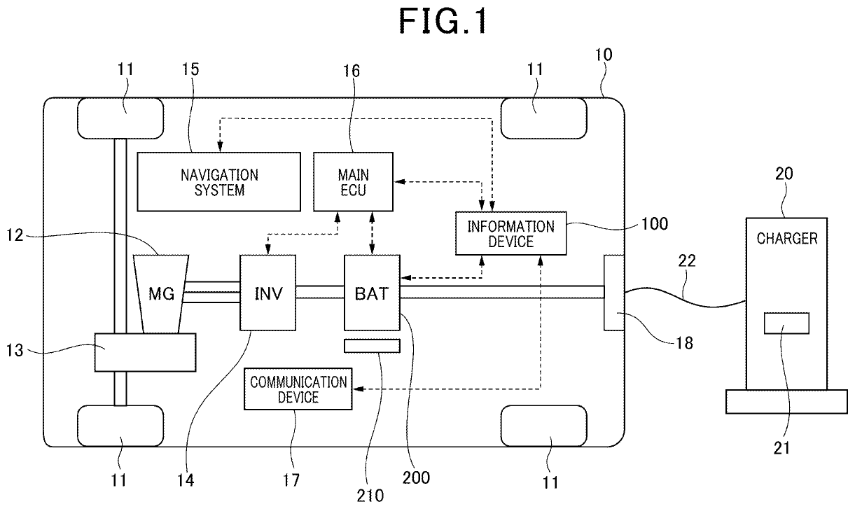

An information device 100 according to one embodiment is a device that may be used by a user of a vehicle 10. Before describing the information device 100, the configuration of the vehicle 10 will be described first. The vehicle 10 is an electric vehicle driven by driving force from a rotating electric machine 12. As illustrated in FIG. 1, the vehicle 10 includes the rotating electric machine 12, an inverter 14, a rechargeable battery 200, a navigation system 15, a main electronic control unit (ECU) 16, and a communication device 17.

The rotating electric machine 12 operates by receiving electric power supplied from the rechargeable battery 200 (described later), and generates a driving force necessary for the vehicle 10 to travel. The rotating electric machine 12 is also referred to as a motor generator. The driving force generated by the rotating electric machine 12 is transmitted to the wheels 11 via a differential 13 to rotate the wheels 11. During braking of the vehicle 10, the rotating electric machine 12 generates regenerative power. The regenerative power is supplied to the rechargeable battery 200 via the inverter 14, which is described next, and stored in the rechargeable battery 200.

The inverter 14 is a power converter that converts direct-current (DC) power supplied from the rechargeable battery 200 into three-phase alternating-current (AC) power and supplies this three-phase AC power to the rotating electric machine 12. During braking of of the vehicle 10, the inverter 14 may also convert the three-phase AC power (regenerative power) generated by the rotating electric machine 12 into DC power and supply this DC power to the rechargeable battery 200 for charging the rechargeable battery 200. Thus, the inverter 14 may be configured as a bidirectional power converter. The operation of the inverter 14 is controlled by the main ECU 16 described later, which enables adjustment of the magnitude of driving and braking forces generated by the rotating electric machine 12. Although not shown in FIG. 1, the inverter 14 includes a controller to perform communicate bidirectionally with the main ECU 16.

The rechargeable battery 200, which may be a lithium-ion battery, is used to store electrical power required for the operation of the rotating electric machine 12. Charging and discharging of the rechargeable battery 200 is controlled by the main ECU 16. Although not shown in FIG. 1, the rechargeable battery 200 includes a controller to communicate bidirectionally with the main ECU 16.

A temperature adjustment device 210 is provided adjacent to the rechargeable battery 200 to adjust the temperature of the rechargeable battery 200. The temperature adjustment device 210 cools the rechargeable battery 200 as necessary to keep the temperature of the rechargeable battery 200 within a predefined target range. The temperature adjustment device 210 may be a device capable of both cooling and heating the rechargeable battery 200. The operation of the temperature adjustment device 210 is controlled by the main ECU 16.

When it becomes necessary to charge the rechargeable battery 200, the driver of the vehicle 10 stops the vehicle 10 in the vicinity of the charger 20. The charger 20 is a facility for charging the rechargeable battery 200 and is installed at each of a plurality of locations in an area where the vehicle 10 travels. The driver of the vehicle 10 connects the end of the cable 22 extending from the charger 20 to a charging port 18 of the vehicle 10, and then operates the charger 20 to start charging.

The charger 20 includes a controller 21 for controlling the operation of the charger 20. When charging is performed, the main ECU 16 of the vehicle 10 and the controller 21 of the charger 20 communicate bidirectionally, for example, via a cable 22. Based on bidirectional communications, the controller 21 appropriately adjusts the magnitude of charging power output from the charger 20.

The navigation system 15 is a system that performs necessary processing to cause the vehicle 10 to reach a destination while acquiring the current location of the vehicle 10, for example, from a GPS sensor. The navigation system 15 includes a screen (not shown) installed in a cabin of the vehicle 10. The navigation system 15 displays on the screen a travel path to reach the destination, or other information.

The main ECU 16 is a control device for governing the overall operation of the vehicle 10. The main ECU 16 is configured as a computer system including a central processing unit (CPU), a read-only memory (ROM), a random-access memory (RAM). As described above, the main ECU 16 controls operations of the inverter 14, the temperature adjustment device 210, and other devices.

The communication device 17 is a device that enables communication outside of the vehicle 10. The information device 100 and the main ECU 16 may use the communication device 17 to perform wireless communication with, for example, a cloud server, and/or to perform wired communication with the charger 20 described later.

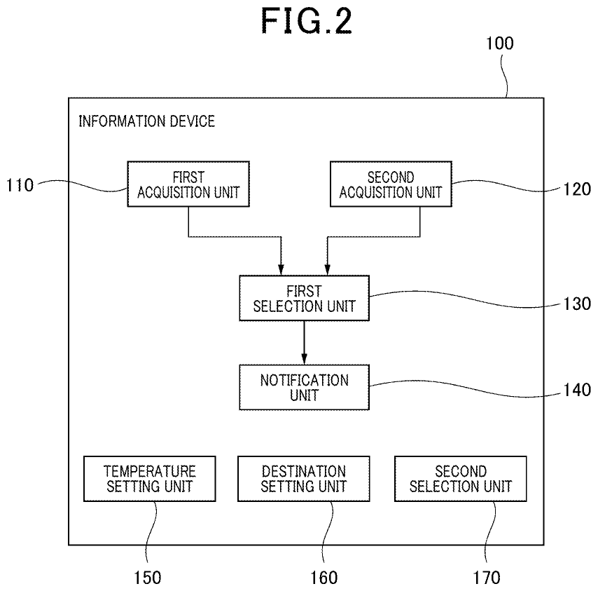

The configuration of the information device 100 will be described with reference to FIGS. 1 and 2. The information device 100 is a device for providing various types of information to users of the vehicle 10, and the like. In the present embodiment, it is the driver of the vehicle 10 who receives the information from the information device 100. However, for example, in a case where the vehicle 10 is an autonomous driving vehicle, a passenger other than the driver may receive the information from the information device 100. A manager or management server that externally manages driving of the vehicle 10 may receive the information from the information device 100. The information provided by the information device 100 includes information about the plurality of chargers 20 around the vehicle 10. Details of such information will be described later.

The information device 100 is configured as a computer system including a CPU, a ROM, and a RAM, and is mounted to the vehicle 10 in the present embodiment. Alternatively, the information device 100 may be configured as a part of the navigation system 15 or as a part of the main ECU 16. Some or all of the functions of the information device 100 may be configured as a cloud server located at a location different from the vehicle 10 or as a portable communication terminal owned by a user of the vehicle 10. In implementing the functions of the information device 100 described below, the specific device configuration of the information device 100 is not limited in any way.

As illustrated in FIG. 2, the information device 100 includes, as functional blocks, a first acquisition unit 110, a second acquisition unit 120, a first selection unit 130, a notification unit 140, a temperature setting unit 150, a destination setting unit 160, and a second selection unit 170.

The first acquisition unit 110 performs a process of acquiring a maximum amount of power chargeable to the rechargeable battery 200. The “maximum amount of power chargeable to the rechargeable battery 200” is a maximum amount of power that the vehicle 10 is allowed to receive from the charging port 18 and store in the rechargeable battery 200, and is determined by factors on the vehicle 10 side, regardless of the specification of the charger 20 connected to the vehicle 10.

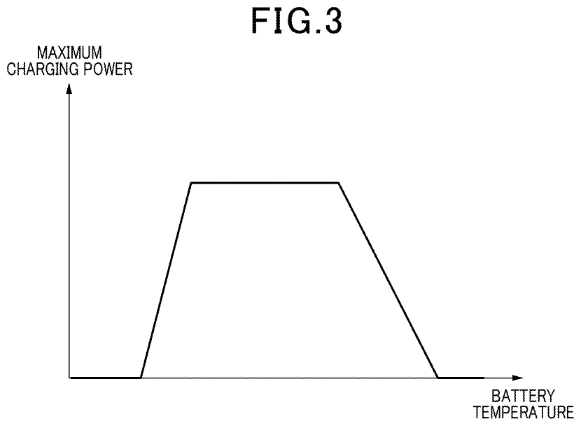

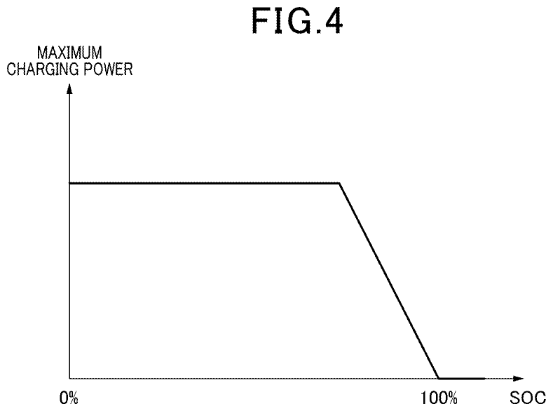

For example, as illustrated in FIG. 3, the maximum amount of power chargeable to the rechargeable battery 200 tends to become small when the temperature of the rechargeable battery 200 is too low and small also when the temperature of rechargeable battery 200 is too high. As illustrated in FIG. 4, the maximum amount of power chargeable to the rechargeable battery 200 tends to become smaller as the state of charge (SOC) of the rechargeable battery 200 approaches 100%.

The first acquisition unit 110 acquires the “maximum amount of power chargeable to the rechargeable battery 200” by, for example, referring to the temperature and SOC of the rechargeable battery 200 acquired from the controller of the rechargeable battery 200 via communication, and a map. In acquiring the maximum amount of power chargeable to the rechargeable battery 200, the specification and/or state of the inverter 14 may be further taken into account.

The second acquisition unit 120 performs a process of acquiring the specification of each of the plurality of chargers 20 in the vicinity of the vehicle 10. The “vicinity of the vehicle 10” is, for example, an area within a predefined distance from the current location of the vehicle 10.

The “specification” of the charger 20 includes, for example, the maximum amount of power that can be output via the cable 22 and a charging fee, which are determined by factors on the charger 20 side, regardless of the specification of the vehicle 10 to which the charger 20 is connected. The charging fee may be a fee per unit of time or fee per unit of power. The second acquisition unit 120 acquires the specifications of the respective chargers 20, for example, by communicating with the controllers 21 of the respective chargers 20 in the vicinity. The second acquisition unit 120 may acquire information from a cloud server that collectively manages the specifications of the plurality of chargers 20.

The first selection unit 130 performed a process of selecting at least one recommended charger from a plurality of chargers 20 in the vicinity of the vehicle 10, i.e., a plurality of chargers 20 whose specifications have been acquired by the second acquisition unit 120. The at least one recommended charger includes a single charger 20 or more than one charger that meets a predefined selection criterion suitable for charging. A selection criterion that the charging time is within a predefined time or a selection criterion that the charging fee is less than or equal to a predefined fee may be employed as the “selection criterion” as mentioned above. Alternatively, for example, a relative selection criterion may be employed, such as that the top three of the plurality of chargers 20 with the first to third shortest charging times or that the top three of the plurality of chargers 20 with the first to third lowest charging fees.

The first selection unit 130 selects the at least one recommended charger based on both the maximum amount of power chargeable to the rechargeable battery 200 acquired by the first acquisition unit 110 and the specifications of the plurality of chargers 20 acquired by the second acquisition unit 120. The specific selection method will be described later.

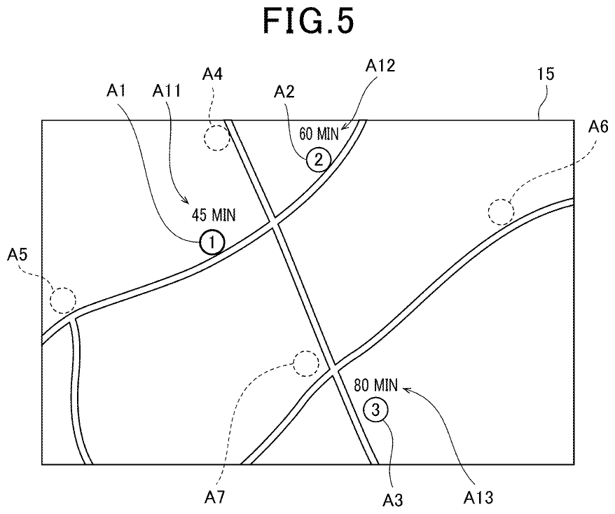

The notification unit 140 performs a process of notifying the driver of the vehicle 10 of the at least one recommended charger selected by the first selection unit 130. The notification unit 140 of the present embodiment provides a notification to the driver of the vehicle 10 by displaying the location of the at least one recommended charger and other information on the screen of the navigation system 15. FIG. 5 illustrates an example of the screen during provision of the notification.

In the example illustrated in FIG. 5, a map of the surrounding area is indicated on the screen of the navigation system 15, and the locations of the chargers 20 are indicated by icons A1 through A7 on this map. Of these icons, icons A1, A2, and A3, as indicated by solid lines, represent the locations of the recommended chargers, and icons A4, A5, A6, and A7, as indicated by dotted lines, represent the locations of the other chargers 20.

For example, of the three icons A1, A2, and A3 indicating the recommended chargers, the icon A1 is highlighted by a bold line. The charger 20 indicated by the icon A1 is the most recommended charger 20 among the recommended chargers, that is, the one selected by the first selection unit 130 as an optimal charger 20 for charging the rechargeable battery 200 of the vehicle 10. This charger 20 is also referred to as an “optimal charger” in the following. In such a manner, the first selection unit 130 also performs a process of selecting one charger as the optimal charger from the plurality of chargers selected as recommended chargers. In a case where there is only one charger 20 selected as the recommended charger, this charger 20 is the optimal charger.

The charger 20 set as the optimal charger may be used as a destination for route guidance, as will be described later. The selection of the optimal charger by the first selection unit 130 may be performed automatically according to a preset criterion as in the present embodiment, or may be performed based on user's selection. For example, one charger selected by a users touch operation, among a plurality of chargers 20 indicated on a touch panel screen of the navigation system 15 as recommended chargers, may be set as the optimal charger by the first selection unit 130.

The character strings A11, A12, and A13 are displayed adjacent to respective ones of the three icons A1, A2, and A3 that indicate the recommended chargers. Each of the character strings A11, A12, and A13 indicates an amount of time required for charging the rechargeable battery 200 of the vehicle 10. The “amount of time” indicated here refers to an amount of time required to charge the rechargeable battery 200 of the vehicle 10 with a specific amount of power. The “specific amount of power” may be the same amount of power for all recommended chargers, or may be a different amount of power for each of the recommended chargers. In the latter case, for example, the amount of time required to charge the rechargeable battery 200 of the vehicle 10 with an amount of power required to travel a distance from the location of each of the recommended chargers to a destination, may be indicated as the character string A11 or the like.

Although the amount of time itself described above may be indicated by the character string A11 or the like, information corresponding to the amount of time may also be indicated by the character string A11 or the like. For example, an estimated time when charging is completed may be indicated by the character string A11 or the like.

In this manner, for each of the selected recommended chargers, the notification unit 140 of the present embodiment also notifies the user of the amount of time required to charge the rechargeable battery 200 of the vehicle 10 with the specific amount of power or information corresponding to the amount of time required to charge the rechargeable battery 200 of the vehicle 10. This allows the user to more easily select an appropriate charger.

What is indicated by the character string A11 or the like may be a target amount of charge. For example, a target amount of power required to travel a distance from the location of each recommended charger to a destination may be indicated as the string A1 or the like. In this case, what is indicated by the character string A1 or the like may be the above target amount of power (in kWh) itself, or may be information corresponding to the above target amount of power. For example, the value of SOC at the time when charging with the target amount of power is completed (in %) may be indicated by the character string A11 or the like. An extension of distance made by charging with the target amount of power may be indicated by the string A11 or the like.

In this manner, the notification unit 140 may also notify the user of the target amount of charge when charging the rechargeable battery 200 or information corresponding to the target amount of charge, for each of the selected recommended chargers. This also allows the user to more easily select an appropriate charger.

What is indicated by the character string A11 or the like may be an amount of power chargeable within a predefined period of time. For example, the amount of power chargeable within a limited (common) time period of 30 minutes may be indicated by the character string A11 or the like. In this case, what is indicated by the character string A11 or the like may be the amount of power chargeable within the predefined period of time (in kWh) itself, or may be information corresponding to the amount of power chargeable within the predefined period of time. For example, what is indicated by the character string A11 or the like may be a value of SOC (in %) at the time when charging with the above amount of power is completed.

In this manner, the notification unit 140 may further provide a notification of the amount of power chargeable within the predefined period of time or information corresponding to the amount of power chargeable within the predefined period of time, for each of the selected recommended chargers. This also allows the user to more easily select an appropriate charger.

The temperature setting unit 150 performs a process of setting a target temperature when the temperature of the rechargeable battery 200 is adjusted by the temperature adjustment device 210. When charging is in progress, the temperature of the rechargeable battery 200 rises. The temperature setting unit 150 sets the target temperature and lowers the temperature of the rechargeable battery 200 in advance before the start of charging such that the temperature of the rechargeable battery 200 does not exceed a predefined upper limit temperature during charging. Therefore, the target temperature to be set is the target temperature of the rechargeable battery 200 at the point in time immediately before the start of charging (in the future). The temperature setting section 150 sets the target temperature provided that the rechargeable battery 200 is charged by the optimal charger described above. The specific method of setting the temperature will be described later.

The destination setting section 160 performs a process of setting a destination to be reached by the vehicle 10. The destination setting unit 160 transmits the location of the optimal charger to the navigation system 15 and causes the navigation system 15 to set the destination to the location of the optimal charger. This allows a route from the current location of the vehicle 10 to the location of the optimal charger to be displayed on the screen of the navigation system 15, thereby initiating guidance along this route. In a case where the vehicle 10 is an autonomous driving vehicle, the destination setting unit 160 may set the destination for autonomous driving to the location of the optimal charger.

The second selection unit 170 performs a process of causing the user to select the selection criterion to be used by the first selection unit 130 to select the recommended chargers. The second selection unit 170 determines the selection criterion described above, for example, by displaying options on the touch panel screen of the navigation system 15 and thereby causing the user to touch one of the options. As described above, the selection criterion for selecting recommended chargers include charging times, charging fees, and other factors. The user selects his or her preferred selection criterion, thereby allowing the recommended chargers to be displayed in accordance with the selected selection criterion.

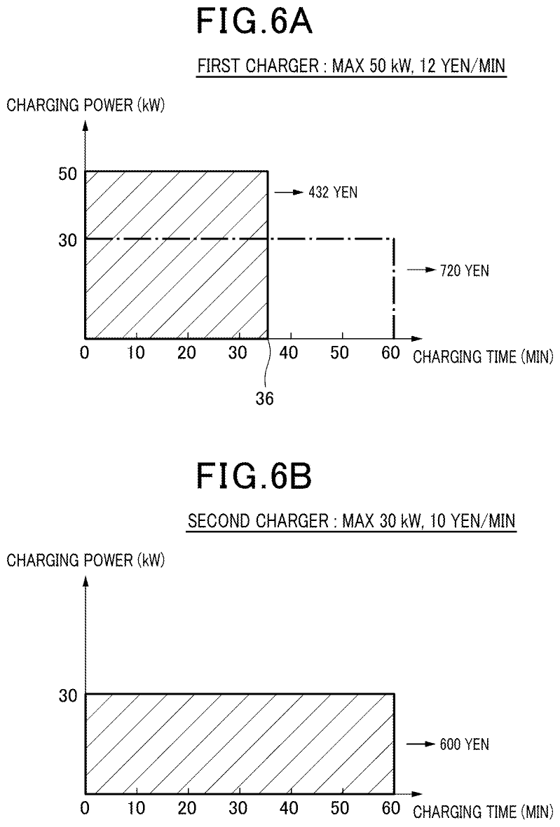

An overview of the method of the first selection section 130 selecting recommended chargers will now be described with reference to FIGS. 6A and 6B. Here, two types of chargers 20 that differ from each other in charging fee are used as examples. It is assumed that the first charger 20 is capable of outputting up to 50 kW and the charging fee is 12 yen per minute. It is assumed that the second charger 20 is capable of outputting up to 30 kW and the charging fee is 10 yen per minute.

A case of either of the above two chargers charging the rechargeable battery 200 of the vehicle 10 with a power amount of 30 kWh is considered. Assuming that the maximum amount of power can be supplied from each of the chargers 20, an amount of time required for charging by the first charger 20 is 36 minutes (=30/50×60 minutes), and the charging fee is 432 yen (=36×12 yen). The area of the hatched area in FIG. 6A represents this charging fee.

On the other hand, under the same assumption, an amount of time required for charging by the second charger 20 is 60 minutes (=30/30×60 minutes) and the charging fee is 600 yen (=60×10 yen). The area of the hatched area in FIG. 6B represents this charging fee.

In the above examples, with the selection criterion based on the charging fee, it would seem that the first charger 20 with the lowest charging fee should be recommended as the recommended charger. However, it is not always possible to supply maximum charging power from the charger 20. For example, in a case where the temperature of the rechargeable battery 200 of the vehicle 10 is decreasing and the acceptable power range is narrowing, it is necessary to reduce the charging power to the upper limit of this power range.

It is assumed that the upper limit of acceptable power at the vehicle 10 has dropped to 30 kW. Charging by the first charger 20 then takes 60 minutes (=30/30×60 minutes), and the charging fee is 720 yen (=60×12 yen). The area of the area surrounded by the dashed-dotted line in FIG. 6A represents the charging fee.

On the other hand, charging by the second charger 20 takes 60 minutes (=30/30×60 minutes) and the charging fee is 600 yen (=60×10 yen), as in the case without the above assumption that the upper limit of acceptable power at the vehicle 10 has dropped to 30 kW. Therefore, in this case, the second charger 20 should be recommended as the recommended charger as the charging fee is lower than when charging is performed by the first charger 20.

For this reason, when selecting the recommended chargers, it is not appropriate to make a determination based solely on the specification of each of the chargers 20 (maximum output power, settings of charging fee, etc.), but it is preferable to further take into account the state of the vehicle 10 that accepts the power.

Therefore, in the information acquisition unit 100 of the present embodiment, the first selection unit 130 is configured to select recommended chargers (or one recommended charger in some situations) based on both the “maximum amount of power chargeable to the rechargeable battery 200” acquired by the first acquisition unit 110 and the “specifications of the plurality of chargers 20 in the vicinity of the vehicle 10” acquired by the second acquisition unit 120. This allows users to be provided with necessary and appropriate information for selecting an appropriate charger.

The first selection unit 130 of the present embodiment, as illustrated in FIGS. 6A and 6B, uses the charging fees as a selection criterion for recommended chargers. That is, the recommended chargers are selected based on the charging fees for charging the rechargeable battery 200 with a specific amount of power. In this case, the first selection unit 130 calculates the charging fees when charging is performed by the respective chargers 20 based on information acquired by the first acquisition unit 110 and other information. The chargers 20 whose charging fees are at or below a predefined criterion are then selected as recommended chargers.

As described previously, a selection criterion excluding charging fees may be used as a selection criterion for recommended chargers. For example, the first selection unit 130 may select recommended chargers based on amounts of time required to charge with a specific amount of power. In this case, the first selection unit 130 calculates charging times when charging is performed by the respective chargers 20 based on information acquired by the first acquisition unit 110 and other information. The chargers 20 whose charging fees are at or below a predefined criterion are then selected as recommended chargers.

For example, the first selection unit 130 may select recommended chargers based on the percentage of power output as renewable energy from each of the chargers 20, in addition to the charging fees and charging times as described above. For example, in a case where there is a plurality of chargers 20 whose charging fees are less than or equal to a certain fee, only those whose percentages of power output as renewable energy exceed a predefined percentage may be selected as recommended chargers. Similarly, for example, in a case where there is a plurality of chargers 20 whose charging times are less than or equal to a certain time, only those whose percentages of power output as renewable energy exceed a predefined percentage may be selected as recommended chargers.

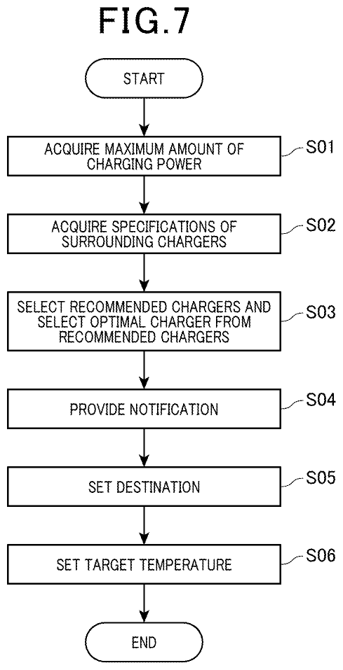

An exemplary process flow performed by the information device 100 will now be described with reference to FIG. 7. Performance of the series of process steps illustrated in FIG. 7 are initiated, for example, at the point in time immediately after the start of travel of the vehicle 10.

First, at step S01, the first acquisition unit 110 performs the process of acquiring a maximum amount of power chargeable to the rechargeable battery 200. As described above, the first acquisition unit 110 calculates and acquires the maximum amount of power chargeable to the rechargeable battery 200 based on the temperature and SOC of the rechargeable battery 200, the specification of the inverter 14, and other factors.

At step S02 subsequent to step S01, the second acquisition unit 120 performs the process of acquiring the specification of each of a plurality of the chargers 20 in the vicinity of the vehicle 10 (also referred to as a plurality of surrounding chargers 20). As described above, the second acquisition unit 120 acquires the specifications of the respective chargers 20 by communicating with their control units 21.

At step S03 subsequent to step S02, the first selection unit 130 performs the process of selecting recommended chargers (where the number of recommended chargers may be one) and the process of selecting an optimal charger from the recommended chargers. As described above, the first acquisition unit 130 selects the recommended chargers and selects the optimal charger from the selected recommended chargers, based on both the “maximum amount of power chargeable to the rechargeable battery 200” acquired at step S01 and the “specifications of the plurality of the chargers 20 in the vicinity of the vehicle 10” acquired at step S02.

At step S04 subsequent to step S03, the notification unit 140 performs the process of providing a notification of the recommended chargers and the optimal charger. As described above, the notification unit 140 uses the screen of the navigation system 15 to provide the notification. The screen used for notification may be a screen dedicated to notification by the information device 100 or a screen of a mobile communication terminal possessed by the user, instead of the screen of the navigation system 15. Alternatively, the notification unit 140 may use voice rather than a screen indication to provide the notification.

At step S05 subsequent to step S04, the destination setting unit 160 performs the process of setting a destination for the vehicle 10 to reach. As described above, the destination setting unit 160 transmits the location of the optimal charger selected at step S03 to the navigation system 15 and sets the destination to the location of the optimal charger.

At step S06 subsequent to step S05, the temperature setting unit 150 performs the process of setting a target temperature for temperature adjustment by the temperature adjustment device 210. As described above, the temperature setting unit 150 sets the target temperature provided that the rechargeable battery 200 is charged by the optimal charger.

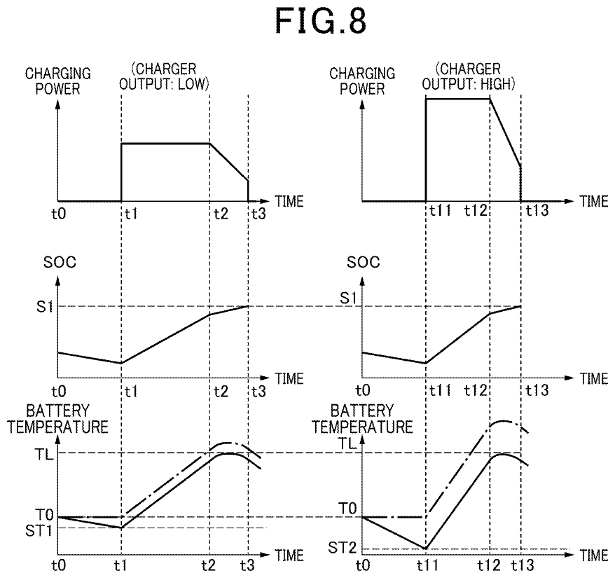

The left-hand side of FIG. 8 illustrates changes in charging power and others in a case where the charger 20 with a relatively low amount of power that can be output is selected as the optimal charger. The right-hand side of FIG. 8 illustrates changes in charging power and others in a case where the charger 20 with a relatively high amount of power that can be output is selected as the optimal charger.

On each of the left- and right-hand sides of FIG. 8, the uppermost part illustrates an example of changes over time in amount of charging power supplied from the charger 20 to the vehicle 10. The middle part illustrates an example of changes over time in amount of power stored in the rechargeable battery 200 (SOC). The lowermost part illustrates an example of changes over time in temperature of the rechargeable battery 200.

In the example on the left-hand side of FIG. 8, the vehicle 10 is connected to the charger 20 and charging is initiated at time t1. After time t1, the SOC of the rechargeable battery 200 gradually increases. After time t2, the charging power gradually decreases as the SOC approaches 100%. At time t3, the SOC reaches 100% and the charging power then becomes 0.

After time t1, the temperature of the rechargeable battery 200 gradually increases during charging. Assuming that the initial temperature at the start of charging is T0, the temperature of the rechargeable battery 200 changes as indicated by the dashed-dotted line in the lower left of FIG. 8, and is likely to exceed the upper temperature limit TL. The upper temperature limit TL is a temperature that has been set in advance as the upper limit of an appropriate temperature range in which the rechargeable battery 200 is unlikely to deteriorate.

In a case where the temperature of the rechargeable battery 200 is expected to be higher than the upper temperature limit TL, the temperature setting unit 150 sets the target temperature ST1 to a temperature lower than TO such that the rechargeable battery 200 is cooled previously during a certain period before the start of charging (the period from time t0 to time t1). The target temperature ST1 is the target temperature of the rechargeable battery 200 to be reached at time t1, and is set to a temperature such that the temperature of the rechargeable battery 200 that rises between time t1 and completion of charging is kept at or below the upper temperature limit TL. In order to set the target temperature ST1 as such a temperature, for example, a simulation may be performed taking into account the outside temperature of the vehicle 10.

In the example on the right-hand side of FIG. 8, the vehicle 10 is connected to the charger 20 and charging is initiated at time t11. After time t11, the SOC of the rechargeable battery 200 gradually increases. After time t12, the charging power gradually decreases as the SOC of the rechargeable battery 200 approaches 100%. At time t13, the SOC reaches 100% and the charging power then becomes 0.

As in the example on the right-hand side of FIG. 8, a relatively large amount of power that can be output from the charger 20 leads to a larger amount of temperature rise of the rechargeable battery 200 after time t11. Therefore, in order to keep the temperature of the rechargeable battery 200 at or below the upper temperature limit TL, it is necessary to set a target temperature ST2 lower than the target temperature ST1.

Thus, the target temperature to be set depends on the maximum amount of power that can be output from the charger 20. Therefore, the temperature setting unit 150 sets an appropriate target temperature to keep the temperature of the rechargeable battery 200 at or below the upper temperature limit TL according to the performance of the charger 20 selected as the optimal charger. This may prevent occurrence of a situation where the rechargeable battery 200 is cooled excessively just in case.

By the way, during a period of time in which charging is being performed by the charger 20, a fraction of power supplied to the vehicle 10 may be consumed by accessories mounted to the vehicle 10, and the remaining power may be supplied to the rechargeable battery 200 to charge the rechargeable battery 200. Such accessories may include, for example, an air conditioner and the temperature adjustment device 210. In such a case, the first acquisition unit 110 may correct the maximum amount of power chargeable to the rechargeable battery 200 based on an amount of power consumed by the accessories, and may acquire the corrected maximum amount of power chargeable to the rechargeable battery 200.

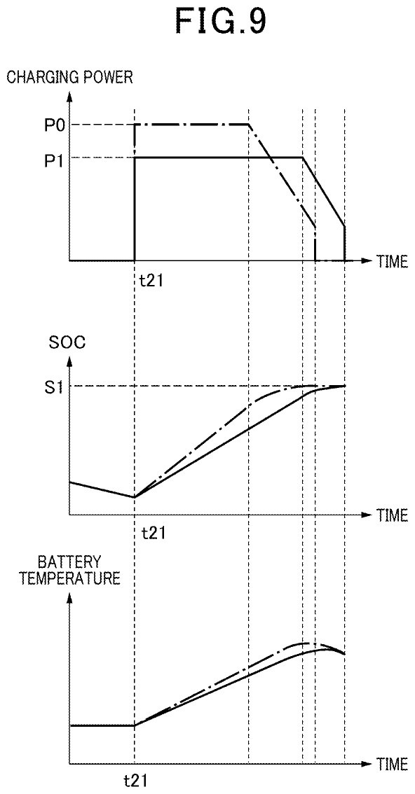

The uppermost part of FIG. 9 illustrates an example of changes over time in charging power supplied from the charger 20 to the vehicle 10. The middle part illustrates an example of changes over time in amount of power stored in the rechargeable battery 200 (SOC). The lowermost part illustrates an example of changes over time in temperature of the rechargeable battery 200. In the example illustrated in FIG. 9, the vehicle 10 is connected to the charger 20 and charging is initiated at time t21.

The maximum amount of power chargeable to the rechargeable battery 200 in a case where the accessories consume no power is P0. In such a case, the charging power, the SOC, and the temperature of the rechargeable battery 200 change as indicated by the respective dashed-dotted lines in FIG. 9.

However, in a case where the accessories consume power, the charger 20 is unable to supply the amount of power P0 to the rechargeable battery 200. Taking into account the amount of power consumed by the accessories, and assuming that the maximum amount of power actually chargeable to the rechargeable battery 200 is P1, the charging power, the SOC, and the temperature of the rechargeable battery 200 may change as indicated by the respective solid lines in FIG. 9. The amount of power acquired by subtracting P1 from P0 corresponds to an amount of power consumed by accessories.

The first acquisition unit 110 calculates the corrected amount of power, P1, by subtracting the amount of power consumed by the accessories from P0. In such a case, the first selection unit 130 uses P1 as the “maximum amount of power chargeable to the rechargeable battery 200” to select the recommended chargers.

As described previously, the second acquisition unit 120 acquires the specifications of the chargers 20 in the vicinity of the vehicle 10 by communicating with the control unit 21 of each of these chargers 20. In a case where the specification of each of the chargers 20 includes charging fees that differ depending on the amount of charging power, the charging fees may be transmitted from the respective chargers 20.

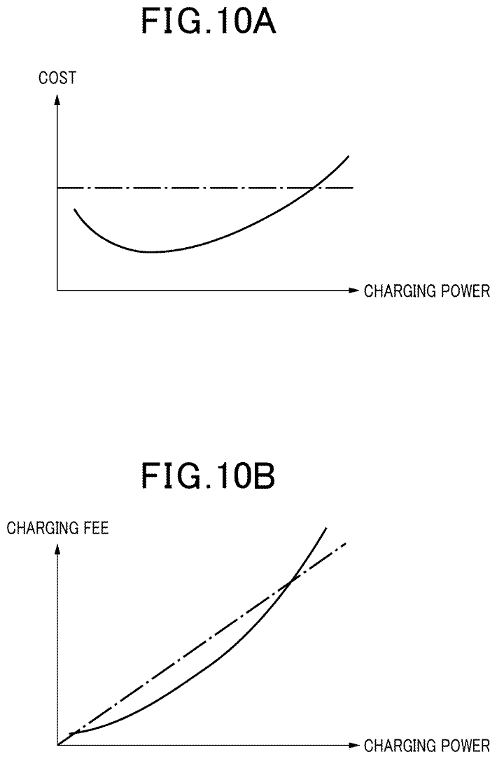

FIG. 10A illustrates an example of relationships between charging power (indicated by the horizontal axis) and cost on the facility side (indicated by the vertical axis). As indicated by the solid line in the upper part, the cost basically increases as the charging power increases, while the cost may also increase as the charging power decreases when the charging power is too low.

FIG. 10B illustrates an example of relationships between charging power (indicated by the horizontal axis) and charging fee (indicated by the vertical axis). Taking into account costs as indicated by the solid line in FIG. 10A, the charging fee may change as indicated by the solid line in FIG. 10B. Assuming that the cost arising from charging power is constant, as indicated by the dashed-dotted line in FIG. 10A, the charging fee is directly proportional to the charging power, as indicated by the dashed-dotted line in FIG. 10B. The “specifications” transmitted from the respective chargers 20 to the second acquisition unit 120 may include a correspondence relationship as indicated by the solid line in FIG. 10B.

The present embodiment is thus far described with reference to specific examples. However, the present disclosure is not limited to these specific examples. Modifications resulting from appropriate design changes applied by those skilled in the art to these specific examples are also included in the scope of the present disclosure as long as the modifications have the features of the present disclosure. The elements, the arrangement of the elements, the conditions, the shapes, and the like of each of the above-described specific examples are not necessarily limited to those exemplified and can be appropriately changed. A combination of the respective elements included in each of the above-described specific examples can be appropriately changed as long as no technical inconsistency exists.

The control devices and methods described herein may be realized using one or more dedicated computers provided by configuring a processor and a memory programmed to execute one or more functions embodied by computer programs. The control devices and methods described herein may be realized using a dedicated computer provided by configuring a processor including one or more dedicated hardware logic circuits. The control devices and methods described herein may be realized using one or more dedicated computers configured by combining a processor and a memory programmed to execute one or more functions with a processor including one or more hardware logic circuits. The computer programs may be stored in a computer-readable, non-transitory tangible storage medium as instructions executed by the computer. A dedicated hardware logic circuit or a hardware logic circuit may be realized by a digital circuit or an analog circuit including a plurality of logic circuits.

What is claimed is:

1. An information device for providing information about one or more chargers for charging a rechargeable battery of a vehicle, the information device comprising:
a first acquisition unit configured to acquire a maximum amount of power chargeable to the rechargeable battery;
a second acquisition unit configured to acquire a specification of each of the one or more chargers in a vicinity of the vehicle;
a selection unit configured to select at least one recommended charger from the one or more chargers based on the maximum amount of power and the specification of each of the one or more chargers in the vicinity of the vehicle; and
a notification unit configured to provide a notification of the selected at least one recommended charger.

2. The information device according to claim 1, wherein
the selected at least one recommended charger comprises a plurality of recommended chargers, and
the selection unit is configured to select one charger as an optimal charger from the plurality of recommended chargers.

3. The information device according to claim 2, wherein
the selection unit is configured to select one charger selected by a user from the plurality of recommended chargers, as the optimal charger.

4. The information device according to claim 2, further comprising
a temperature setting unit configured to set a target temperature of the rechargeable battery at a point in time immediately before charging, provided that the rechargeable battery is charged by the optimal charger.

5. The information device according to claim 2, further comprising
a destination setting unit configured to set a destination to be reached by the vehicle to a location of the optimal charger.

6. The information device according to claim 1, wherein
the selection unit is configured to select the at least one recommended charger based on charging fees for the one or more chargers charging the rechargeable battery of the vehicle with a specific amount of power.

7. The information device according to claim 1, wherein
the selection unit is configured to select the at least one recommended charger based on amount of time required for the one or more chargers charging the rechargeable battery of the vehicle with a specific amount of power.

8. The information device according to claim 6, wherein
the selection unit is configured to select the at least one recommended charger based on a percentage of power output as renewable energy from each of the one or more chargers.

9. The information device according to claim 7, wherein
the selection unit is configured to select the at least one recommended charger based on a percentage of power output as renewable energy from each of the one or more chargers.

10. The information device according to claim 1, wherein
the selection unit is referred to as a first selection unit, and
the information device further comprises a second selection unit configured to cause a user to select a selection criterion for the first selection unit to select the at least one recommended charger.

11. The information device according to claim 1, wherein
the notification unit is configured to further provide a notification of a target amount of charge or information corresponding the target amount of charge, for each of the selected at least one recommended charger.

12. The information device according to claim 1, wherein
the notification unit is configured to further provide a notification of an amount of power chargeable within a predefined period of time or information corresponding to the amount of power chargeable within the predefined period of time, for each of the selected at least one recommended charger.

13. The information device according to claim 1, wherein
the notification unit is configured to further provide a notification of an amount of time required to charge the rechargeable battery of the vehicle with a specific amount of power or information corresponding to the specific amount of power, for each of the selected at least one recommended charger.

14. The information device according to claim 1, wherein
the first acquisition unit is configured to correct the maximum amount of power chargeable to the rechargeable battery based on an amount of power consumed by accessories mounted to the vehicle.

15. A method of providing information about one or more chargers for charging a rechargeable battery of a vehicle, the method comprising:
acquiring a maximum amount of power chargeable to the rechargeable battery;
acquiring a specification of each of the one or more chargers in a vicinity of the vehicle;
selecting at least one recommended charger from the one or more chargers based on the maximum amount of power and the specification of each of the one or more chargers in the vicinity of the vehicle; and
providing a notification of the selected at least one recommended charger.

16. An information device for providing information about one or more chargers for charging a rechargeable battery of a vehicle, the information device comprising:
a non-transitory memory storing one or more computer programs; and
a processor executing the one or more programs to:
acquire a maximum amount of power chargeable to the rechargeable battery;
acquire a specification of each of the one or more chargers in a vicinity of the vehicle;
select at least one recommended charger from the one or more chargers based on the maximum amount of power and the specification of each of the one or more chargers in the vicinity of the vehicle; and
provide a notification of the selected at least one recommended charger.
